(19) United States
(12) Patent Application Publication
(10) Pub. No.: US 2010/0264600 A1
(43) Pub. Date: Oct. 21, 2010

(54) Pneumatic mechanical seal

(76) Inventor: Richard Lee Willms, Omaha, NE (US)

Correspondence Address: Richard Lee Willms, 1327 South 165th Street, Omaha, NE, 68130, US

(21) Appl. No.: 12/485,892

(22) Filed: Jun. 16, 2009

Related U.S. Application Data
(60) Provisional application No. 61/171,438, filed on Apr. 21, 2009.

(51) Int. Cl. F16J 15/38; F16J 15/34

(52) U.S. Cl. 277/390; 277/407; 277/404

(57) ABSTRACT

A mechanical seal device that creates a positive seal between a shaft and machine while allowing a cylinder to move its full motion and at the same time allowing movement in additional directions to maintain a seal due to operational movement or wear of the machine. The subject seal secures a housing/shaft area of a low or non-pressurized unit containing solid media where the shaft penetrates the machine housing and does not rotate but moves in multiple directions during normal operation.

This application emanates from a previous filed provisional application; 61/171,438 filed on Apr. 21, 2009

### FIELD OF THE INVENTION

The present invention relates to a pneumatic mechanical seal. More specifically, a seal designed to contain solid media in the area where a non-rotating shaft penetrates a housing or storage unit of a low or non-pressurized nature. This seal can be used in any application where the shaft does not rotate but moves in more than one direction. This seal is used for machines, storage tanks, etc., filled with solid media such as sand, coal, plastic beads or any other substance, to seal a housing/shaft area preventing solid media from escaping.

### BACKGROUND OF THE INVENTION

The design was created to seal the area between a housing and a shaft penetrating the housing. This design is unique because it was created to seal a housing/shaft area of a low or non-pressurized unit where the shaft does not rotate but moves in more than one direction. An example of this type of machinery is a coal crusher with external hydraulic cylinders. The crusher itself is a pressurized unit with various sizes of abrasive coal medium moving around within the housing. The hydraulic cylinder is mounted to the floor outside the coal crusher while the shaft is connected to a crushing roller on the inside of the housing.

The previous design was an accordion cloth style boot attached to the upper housing and lower part of the hydraulic shaft to create a seal. It was made with a zipper sewn in vertically to allow installation and removal from around the shaft. This was clamped at the top and bottom using hose clamps. The cloth boot design was original manufacturer equipment installed on the coal crushers. My new design eliminates the boot completely and uses metal, Teflon, and plant air pressure to create a seal between the moving shaft and stationary housing. This seal can be installed on any application where a non-rotating shaft penetrates a housing or storage unit filled with sand, coal, or any other abrasive substance. This design is versatile and by using various seal styles, it will fit many shaft applications at varying angles and positions.

The pneumatic mechanical seal creates a positive seal while allowing a shaft to move its full motion while moving in a perpendicular motion at the same time. Note: Excessive horizontal movement on a coal crusher is only due to wear and is usually minimal. However, the design allows for maximum wear without failure to the seal.

### SUMMARY OF THE INVENTION

The air introduced into the air chamber (9) flows through the air access (7) to the labyrinth (8) cut into the Teflon seal (2). Since the air pressure is 3 times greater than operating pressure in the crusher housing, the seal remains free of coal media. The roller shaft (10) is free to move up and down through the Teflon seal (2). Teflon is used due to its tolerance to high temperatures and friction capabilities. As the coal crusher wears, the roller shaft may move horizontally but the seal is designed to move with it. The Teflon seal (2) will slide horizontally in the air chamber (9) as the roller shaft moves during operation. This is why this design is so innovative. It is the only seal designed to work for multiple shaft movements.

### BRIEF DESCRIPTION OF THE DRAWING

FIG. 1;

This is an assembly view. It indicates how the machined pieces are attached to create a seal by closing the gap between the shaft and machine housing. A device can only be successful if it creates a seal and, at the same time, allows the shaft to move in more than one direction. The pneumatic mechanical was designed specifically for this purpose.

FIG. 2.

This is a view showing half of the seal installed on the machine and shaft. This cut away diagram is the best view for visualizing how the seal operates because it shows the airflow path and how the Teflon seal can move within the air chamber.

FIG. 3.

This view also shows half of a similar style seal installed on a non-perpendicular shaft, or a shaft that is at an odd angle during operation. It is a ball and socket type seal that operates in the exact same way. It is designed for use when the shaft is not perpendicular to the housing. It moves in more than one direction at the same time.

### DETAILED DESCRIPTION OF THE INVENTION

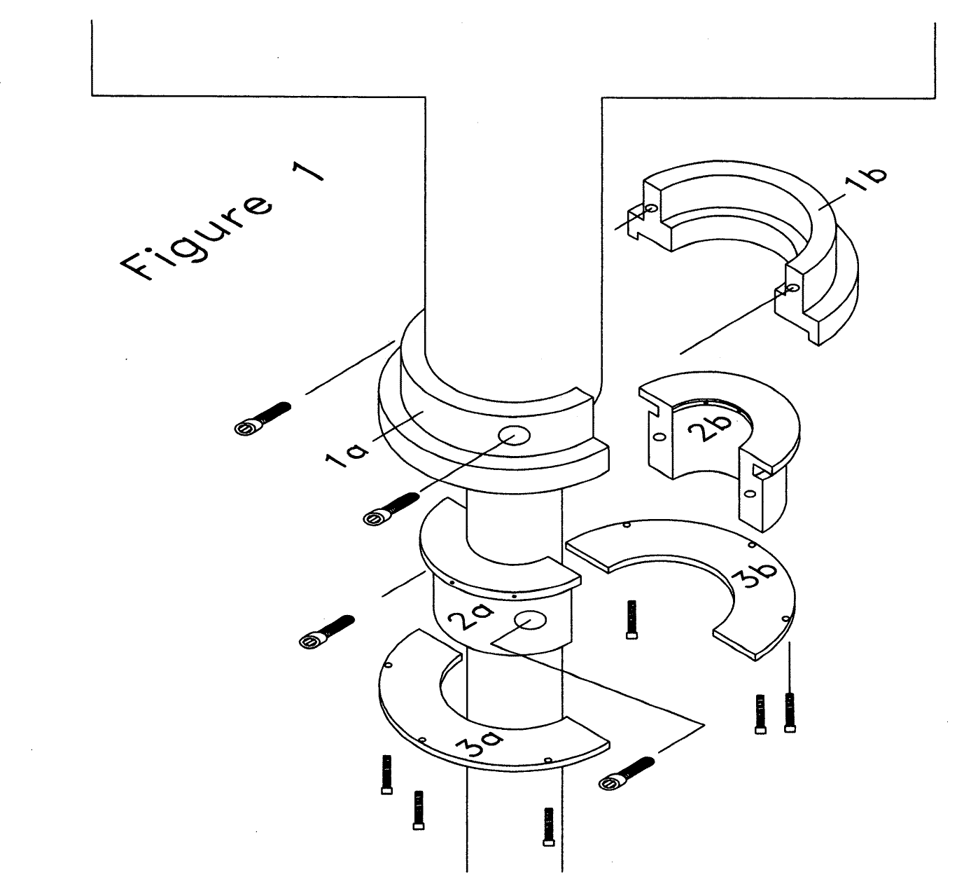

Please refer to FIG. 1. This shows the three main parts of the seal in halves. The seal is machined in halves to allow easy installation. Otherwise the shaft must be disconnected before the seal can be installed. However, they can be made either way, because the result is still the same.

Bolt parts 1a and 1b (in picture 1) together to form one piece, which is the pneumatic mechanical seal body. This seal body is machined to fit any housing. In this case it is a coal crusher housing. The mechanical seal body is then installed on the crusher housing and tightened. Connect parts 2a and 2b around the shaft to make up the Teflon seal. This is installed after the seal body is in place. The Teflon seal is machined to fit the hydraulic cylinder shaft. Slide the Teflon seal up the shaft until it is touching the seal body.

Install the retainer plate (parts 3a and 3b) with fasteners. The retainer plate keeps the Teflon seal in place and creates an air chamber, which will be explained on picture 2. In the last step, an air supply must be connected to the seal body. Pneumatic seal assembly is now complete

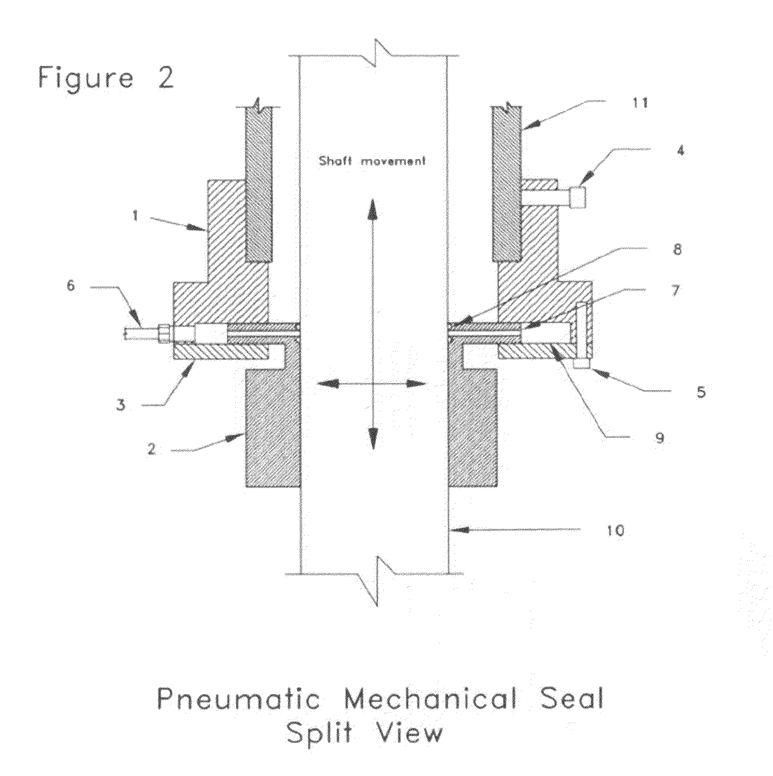

Please refer to FIG. 2. The mechanical seal body (1) is fastened to the crusher housing (11). The seal body is drilled and tapped to accept mounting fasteners (4) that can be tightened against the crusher housing. Each application is different so the number of fasteners and their location may vary.

The Teflon seal (2) is machined to fit the roller hydraulic shaft (10). The Teflon seal is held into place by the retainer plate (3). The retainer plate (3) is bolted to the seal body (1) with fasteners evenly spaced. Each application is different so the number and their location may vary.

The mechanical seal body (1) is drilled and tapped to accept an air supply connection (6). This allows flow into the air chamber (9). From the air chamber (9) air moves through the access holes (7) to the labyrinth recess (8) creating an air seal at that location. The air supply must be regulated to 3 times higher than normal operating pressure of the coal crusher or other applications. In my testing application, the coal crusher is approximately 4-5 psi and the air is regulated at 15 psi.

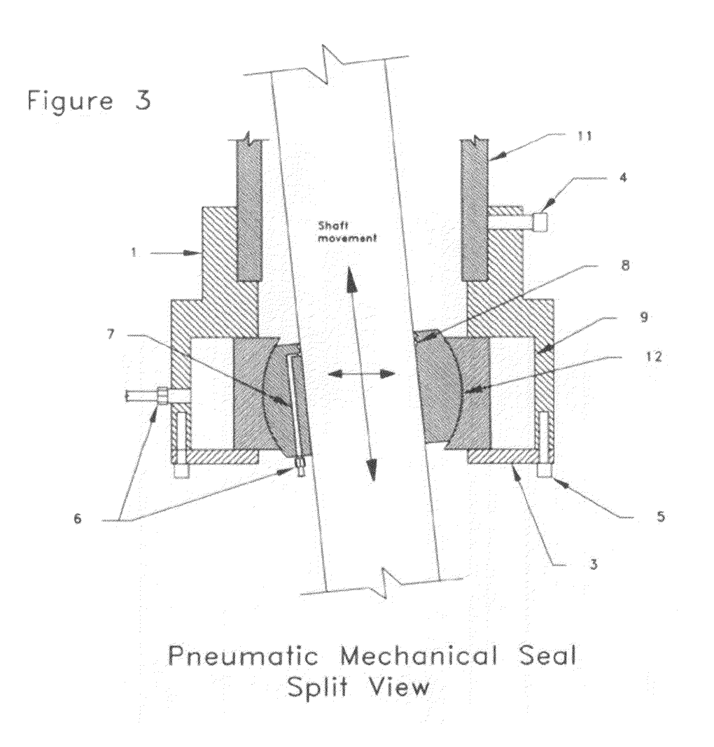

Please refer to FIG. 3. This design is for installation on a non-perpendicular shaft. It allows for movement in more than one direction. It is a ball and socket that allows the shaft to move at a full stroke and at the same time allows movement side to side within the air chamber to create a seal.

I claim:

1. A pneumatic mechanical seal comprised of a machined fit body (1) a Teflon seal within the machined fit body (2) a retainer plate (3) an air supply connection (6) an air chamber (9) access holes (7) and a labyrinth recess (8).

2. A pneumatic mechanical seal of claim 1 wherein the seal is used on machines with an exterior, non-rotating shaft, penetrating the machine, or storage unit housing and requiring a seal to keep solid media from escaping.

3. A pneumatic mechanical seal of claim 1 wherein the machined fit body of the seal can be manufactured from any metallic or plastic materials.

4. A pneumatic mechanical seal of claim 1 wherein the Teflon seal can be replaced by other soft materials or non-ferrous metals in lower operating temperatures.

5. A pneumatic mechanical seal of claim 1 wherein the body, seal and retailer plate can be manufactured in multiple pieces for easy installation.

6. A pneumatic mechanical seal of claim 1 wherein the use of air pressure within the seal shields the shaft from abrasive materials.

7. A pneumatic mechanical seal of claim 1 wherein air pressure is optional.

8. A pneumatic mechanical seal of claim 1 wherein shaft movement of any direction can be achieved.

9. A pneumatic mechanical seal of claim 1 wherein installation of the seal can be accomplished in any position or elevation.

10. A pneumatic mechanical seal of claim 1 wherein the body embodies a ball and socket seal for an application fitting a shaft that is not perpendicular with the housing.
